(19) United States
(12) Patent Application Publication
(10) Pub. No.: US 2025/0278950 A1
(43) Pub. Date: Sep. 4, 2025

(54) INFORMATION PROVISION DEVICE, INFORMATION PROVISION METHOD, AND PROGRAM

(71) Applicant: HONDA MOTOR CO., LTD., Tokyo (JP)

(72) Inventor: Masahiro Daimon, Wako-shi (JP)

(21) Appl. No.: 19/058,074

(22) Filed: Feb. 20, 2025

(30) Foreign Application Priority Data
Mar. 4, 2024 (JP) 2024-032171

(51) Int. Cl. G06V 20/59; G06F 3/01; G06V 20/56

(52) U.S. Cl. CPC G06V 20/597; G06F 3/013; G06V 20/56

(57) ABSTRACT

The information provision device includes a detection part, a determination part, an extraction part, and a provision part. The determination part determines whether driving of the vehicle performed by a driver is a desirable action or an undesirable action with respect to a predetermined criterion on the basis of one or both of the behavior of the vehicle detected by the detection part and an image captured by an imaging part that images a surrounding situation of the vehicle. The extraction part extracts a first image in a first predetermined time before a first time at which the desirable action has been performed or a second image in a second predetermined time before a second time at 10 which the undesirable action has been performed out of images captured by the imaging part. The provision part provides content corresponding to a type of the action using the extracted image.

### CROSS-REFERENCE TO RELATED APPLICATION

Priority is claimed on Japanese Patent Application No. 2024-032171, filed Mar. 4, 2024, the content of which is incorporated herein by reference.

### BACKGROUND OF THE INVENTION

### Field of the Invention

The present invention relates to an information provision device, an information provision method, and a program.

### Description of Related Art

Recently, measures for providing access to a sustainable transportation system in consideration of persons in vulnerable situations out of traffic participants have been actively taken. For the purpose of realizing the same, research and development for improving safety and convenience of traffic through research and development associated with preventive safety technology has been focused on. In the related art, when undesirable actions or desirable actions are carried out while driving a vehicle or the like, awareness programs for reducing accidents in similar scenes by sharing that scene with other persons or awareness programs for performing desirable actions have been undertaken. For example, reducing the number of scenes in which a dangerous accident is likely to occur (near-miss scenes) has been attempted (for example, Patent Document 1 (Japanese Patent No. 7021899)).

### SUMMARY OF THE INVENTION

However, in the related art, scene information which is shared with other persons may not be easily provided. For example, information may be scattered, and it may be difficult to identify and provide a scene in which a particular action or event or the like (for example, a near-miss action or event) occurs and in what place and at what time it occurred.

The present invention was made in consideration of the aforementioned circumstances, and an objective thereof is to provide an information provision device, an information provision method, and a program that can easily provide information of a scene which is shared by other persons. Another objective thereof is to better contribute to development of a sustainable transportation system.

An information provision device, an information provision method, and a program according to the present invention employ the following configurations.

(1) According to an aspect of the present invention, there is provided an information provision device including: a detection part configured to detect behavior of a vehicle; a determination part configured to determine whether driving of the vehicle performed by a driver is a desirable action or an undesirable action with respect to a predetermined criterion on the basis of one or both of the behavior of the vehicle detected by the detection part and an image captured by an imaging part that images a surrounding situation of the vehicle; an extraction part configured to extract a first image in a first predetermined time before a first time at which the desirable action has been performed or a second image in a second predetermined time before a second time at which the undesirable action has been performed out of images captured by the imaging part; and a provision part configured to provide content corresponding to a type of the action using the extracted image.

(2) In the aspect of (1), the content may be includes the first image or the second image, presents a question corresponding to the type of the action before performing the action, and does not require an answer to the question.

(3) In the aspect of (1) or (2), the determination part may determine whether driving of the vehicle performed by the driver is a desirable action or an undesirable action with respect to the predetermined criterion on the basis of the image captured by the imaging part and the behavior of the vehicle, and the determination part may determine whether driving of the vehicle performed by the driver is a desirable action or an undesirable action with respect to the predetermined criterion by inputting the image and the behavior of the vehicle to a trained model which has been trained to output a type of the action when the image and the behavior of the vehicle are input thereto.

(4) In the aspect of (1) or (2), the information provision device may further include a gaze detecting part configured to detect a direction of a gaze of the driver, the determination part may determine whether driving of the vehicle performed by the driver is a desirable action or an undesirable action with respect to the predetermined criterion on the basis of information indicating the image captured by the imaging part, the behavior of the vehicle, and the direction of the gaze, and the determination part may determine whether driving of the vehicle performed by the driver is a desirable action or an undesirable action with respect to the predetermined criterion by inputting the image, the behavior of the vehicle, and the information indicating the direction of the gaze to a trained model which has been trained to output a type of the action when the image, the behavior of the vehicle, and the information indicating the direction of the gaze are input thereto.

(5) In the aspect of (4), the trained model may be a model which has been trained using training data, the training data may include the image, the behavior of the vehicle, the information indicating the direction of the gaze, and correct-answer data, and the correct-answer data may be information indicating a type of an action based on a combination of the image, the behavior of the vehicle, and the information indicating the direction of the gaze.

(6) In the aspect of (5), the trained model may output information indicating that the undesirable action has been performed when the behavior of the vehicle deviates from the criterion based on the situation in the image by a predetermined value or more, or the trained model may output information indicating that the undesirable action has been performed when the direction of the gaze deviates from a criterion direction based on the situation in the image by a predetermined value or more.

(7) In the aspect of (1) or (2), the detection part may be mounted in the vehicle or a device installed in the vehicle, and the determination part may be provided in a device other than the vehicle.

(8) According to another aspect of the present invention, there is provided an information provision method that is performed by a computer, the information provision method including: detecting behavior of a vehicle; determining whether driving of the vehicle performed by a driver is a desirable action or an undesirable action with respect to a predetermined criterion on the basis of one or both of the detected behavior of the vehicle and an image captured by an imaging part that images a surrounding situation of the vehicle; extracting a first image in a first predetermined time before a first time at which the desirable action has been performed or a second image in a second predetermined time before a second time at which the undesirable action has been performed out of images captured by the imaging part; and providing content corresponding to a type of the action using the extracted image.

(9) According to another aspect of the present invention, there is provided a program causing a computer to perform: detecting behavior of a vehicle; determining whether driving of the vehicle performed by a driver is a desirable action or an undesirable action with respect to a predetermined criterion on the basis of one or both of the detected behavior of the vehicle and an image captured by an imaging part that images a surrounding situation of the vehicle; extracting a first image in a first predetermined time before a first time at which the desirable action has been performed or a second image in a second predetermined time before a second time at which the undesirable action has been performed out of images captured by the imaging part; and providing content corresponding to a type of the action using the extracted image.

According to the aspects of (1) to (9), it is possible to easily provide information of a scene which is shared by other persons by providing content corresponding to a type of a driver's action. For example, by using the content which is provided on the basis of the type of the driver's action, it is possible to encourage being conscious of modifying an action for improvement of driving when the driver's action is a negative driving action and to arouse a driving consciousness of having more consideration of other traffic participants when the driver's action is a positive driving action.

According to the aspect of (2), an associated question is output according to a timing at which a driving action scene is reproduced while providing the driving action scene as a video or an image with a position going back by a predetermined time from a time point at which the corresponding event has occurred as a start point, but the question does not have a format of answering the question. Accordingly, it is possible to reduce a driver's burden and to expect a coaching effect of bringing out a driver's spontaneous action by not forcing answering. Action modification is prompted using the question when the driver's action is a negative driving action, and an incentive is given using the question when the driver's action is a positive driving action.

According to the aspect of (3), it is possible to understand what the driving action is (for example, a dangerous action or an exemplary action) using the acquired data.

According to the aspect of (4) or (5), it is possible to more accurately determine a type of an action by also using the driver's gaze.

According to the aspect of (6), since a model trained to output an appropriate action type according to the behavior of the vehicle or the direction of the gaze is constructed, it is possible to more accurately determine an action type.

According to the aspect of (7), since the detection part is mounted in the vehicle or a device installed in the vehicle and the determination part is provided in a device other than the vehicle, it is possible to reduce a process load in the vehicle or the device installed in the vehicle.

### BRIEF DESCRIPTION OF THE DRAWINGS

FIG. 1 is a diagram illustrating an example of a functional configuration of an information provision device 1.

FIG. 2 is a diagram illustrating information which is input to a trained model 194 and information which is output from the trained model 194.

FIG. 3 is a flowchart illustrating an example of a process flow that is performed by an extraction device 100.

FIG. 4 is a flowchart illustrating an example of a process flow that is performed by a provider server 200.

FIG. 5 is a diagram illustrating video content that is provided by the provider server 200.

FIG. 6 is a diagram illustrating video content that is provided by the provider server 200.

FIG. 7 is a diagram illustrating an example of details of extraction data 260 which is stored in a storage part 250 of the provider server 200.

FIG. 8 is a flowchart illustrating an example of a process flow that is performed by the provider server 200.

FIG. 9 is a diagram illustrating an example of information that is provided to a user.

FIG. 10 is a diagram illustrating an example of training data.

### DETAILED DESCRIPTION OF THE INVENTION

Hereinafter, an information provision device, an information provision method, and a program according to an embodiment of the present invention will be described with reference to the accompanying drawings.

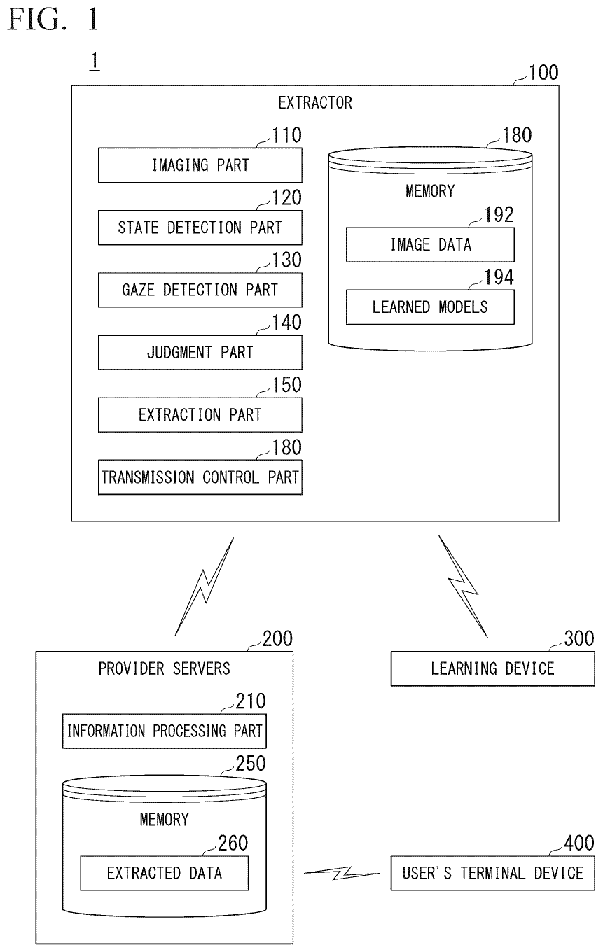

FIG. 1 is a diagram illustrating an example of a functional configuration of an information provision device 1. The information provision device 1 includes, for example, an extraction device 100, a provider server 200, a learning device 300, and a user terminal device 400. Some or all of functional constituents of the extraction device 100, some or all of functional constituents of the provider server 200, or some or all of functional constituents of the learning device 300 may be provided in different devices. For example, some or all of the functional constituents of the extraction device 100 may be included as functional constituents of the provider server 200, and vice versa. The functional constituents of the information provision device may be distributed over a plurality of devices or may be provided in a single device.

### [Extraction Device]

The extraction device 100 is, for example, a device that is mounted or installed in a vehicle. The vehicle is, for example, a vehicle with two wheels, a motorbike, or a micromobility. In the following description, it is assumed that the vehicle is a vehicle with four wheels. The extraction device 100 may be a drive recorder or a smartphone of a user installed in the vehicle.

The extraction device 100 includes, for example, an imaging part 110, a state detecting part 120, a gaze detecting part 130, a determination part 140, an extraction part 150, a transmission control part 160, and a storage part 180. Among these functional constituents, the state detecting part 120, the gaze detecting part 130, the determination part 140, the extraction part 150, and the transmission control part 160 are realized, for example, by causing a hardware processor such as a central processing unit (CPU) to execute a program (software). Some or all of these constituents may be realized by hardware (a circuit unit including circuitry) such as a large scale integration (LSI) circuit, an application-specific integrated circuit (ASIC), a field-programmable gate array (FPGA), a graphics processing unit (GPU), or a system-on-chip (SOC) or may be cooperatively realized by software and hardware. The program may be stored in a storage device (a storage device including a non-transitory storage medium) such as a hard disk drive (HDD) or a flash memory in advance or may be stored in a detachable storage medium (a non-transitory storage medium) such as a DVD or a CD-ROM and installed by setting the storage medium into a drive device.

The storage part 180 may be realized by the aforementioned various storage devices, a solid state drive (SSD), an electrically erasable programmable read only memory (EEPROM), a read only memory (ROM), a random access memory (RAM), or the like. The storage part 180 stores, for example, image data (video data) 192 and a trained model 194. The image data is image data (a video) captured by the imaging part 110. The trained model 194 will be described later.

The imaging part 110 is a camera that images a surrounding situation of the vehicle. For example, the imaging part 110 images a situation in an arbitrary direction (for example, a forward direction) of the vehicle.

The state detecting part 120 detects a state of the vehicle. The state of the vehicle includes, for example, acceleration, deceleration, and a yaw rate of the vehicle. The state detecting part 120 detects the state on the basis of detection results from sensors in the vehicle or a terminal device provided in the vehicle. The state of the vehicle can also be referred to as information indicating a driver's driving state. The state of the vehicle may be time-series data (the same is true of learning).

The gaze detecting part 130 detects a direction of a driver's gaze. The gaze detecting part 130 identifies a driver's gaze from an image captured by a driver monitor camera that is provided in the vehicle to image a driver and detects the direction of the driver's gaze on the basis of the identification result. The direction of the driver's gaze is detected using known techniques.

The determination part 140 determines whether driving of the vehicle performed by the driver is a desirable action or an undesirable action with respect to a predetermined criterion on the basis of one or both of behavior of the vehicle and an image captured by the imaging part. The determination part 140 may perform the determination using the trained model 194 as will be described later or may perform the determination by analyzing one or both of the behavior of the vehicle and an image captured by the imaging part. In the latter, the determination part 140 performs the determination on the basis of whether the behavior (a degree of change of acceleration or a raw rate) of the vehicle deviates from a predetermined criterion by a predetermined degree or more. The determination part 140 performs the determination by analyzing an image using a known image analysis algorithm. The determination part 140 determines a desirable action or an undesirable action by using these determinations together. One or both of the determination part 140 and the extraction part 150 which will be described later may be provided in a device (for example, the provider server 200) other than the vehicle.

The extraction part 150 extracts a first image (specifically a video) in a first predetermined time before a first time at which a desirable action has been performed or a second image (specifically a video) in a second predetermined time before a second time at which an undesirable action has been performed out of images captured by the imaging part 110. Details of the processes performed by the determination part 140 and the extraction part 150 will be described later.

The transmission control part 160 provides the video (image) extracted by the extraction part 150 to the provider server 200. The transmission control part 160 transmits information of the weather, the time, and the season when the video has been captured which is the information to the provider server 200 in correlation with the video. The weather may be estimated from an image extracted by the extraction device 100 or may be acquired from another device.

### [Provider Server]

The provider server 200 includes, for example, an information processing part 210 and a storage part 250. The information processing part 210 is realized, for example, by causing a hardware processor such as a CPU to execute a program (software). Some or all of these constituents may be realized by hardware (a circuit unit including circuitry) such as an LSI, an ASIC, an FPGA, a GPU, or an SOC or may be cooperatively realized by software and hardware.

The information processing part 210 generates video content (or image content) using the video provided from the extraction device 100. The information processing part 210 generates video content, for example, by adding a telop including predetermined wordings to the video. The information processing part 210 provides the generated video content to the user terminal device 400. Details of this process will be described later.

Extraction data 260 is stored in the storage part 250. The extraction data 260 is data extracted by the extraction device 100 (details of which will be described later).

The process of the learning device 300 will be described later.

### [Trained Model]

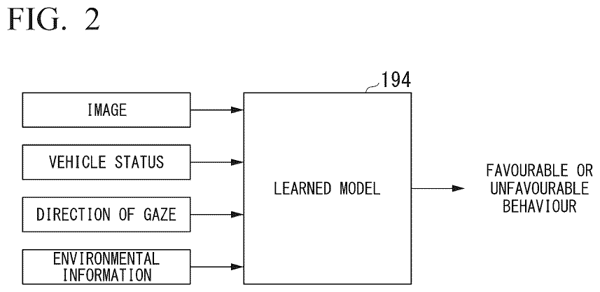

FIG. 2 is a diagram illustrating information which is input to the trained model 194 and information which is output from the trained model 194. When an image captured by the imaging part 110, a state of the vehicle at the timing at which the image has been captured, information indicating a direction of the driver's gaze at that timing, and environment information (the weather, the date and time, or the like when the image has been captured) are input, the trained model 194 outputs information indicating a type of a driver's action at that timing according to the input information.

The state of the vehicle is behavior of the vehicle such as acceleration in a longitudinal direction of the vehicle, acceleration in a lateral direction of the vehicle, a yaw rate of the vehicle, and a degree of change thereof. More specifically, the state of the vehicle is an index (an index indicating a degree of change of an index) indicating a degree of deviation between the index indicating the behavior of the vehicle acquired before a predetermined time and the index indicating the behavior of the vehicle acquired in this time. The weather information may be estimated from an image by the extraction device 100 or may be acquired from another device.

The information indicating a type of a driver's action is, for example, information indicating whether the driver's action is desirable or undesirable. Specifically, the type of the driver's action is a type indicating whether the driver's driving is driving causing a near-miss event. The trained model 194 may output information indicating another type in addition to the aforementioned type. The other type is a type (for example, another type) other than the types indicating that the driver's action is desirable and undesirable.

### [Flowchart (1)]

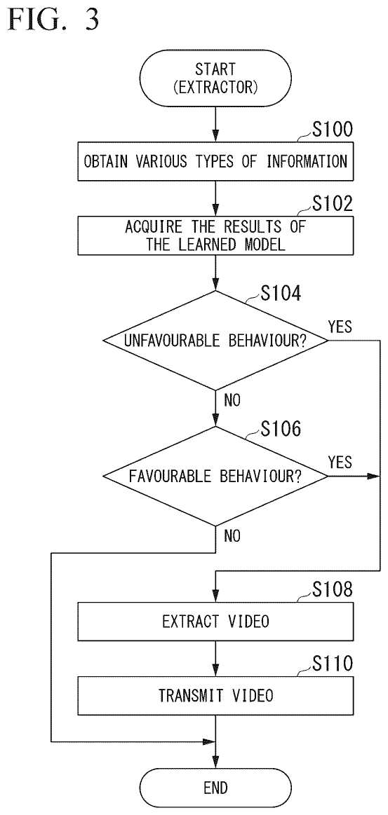

FIG. 3 is a flowchart illustrating an example of a process flow that is performed by the extraction device 100. For example, the process flow in this flowchart is repeatedly performed at predetermined time intervals.

First, the extraction device 100 acquires various types of information (information indicating an image, a state of the vehicle and a direction of a gaze) (Step S100). Then, the extraction device 100 inputs the acquired information to the trained model 194 and acquires a result output from the trained model 194 (Step S102).

Then, the extraction device 100 determines whether the driver is performing an undesirable action on the basis of the information acquired in Step S102 (Step S104). When the determination result of Step S104 is negative, the extraction device 100 determines whether the driver is performing a desirable action on the basis of the information acquired in Step S102 (Step S106). When the determination result of Step S106 is negative, this routine of the flowchart ends.

When the determination result of Step S104 is positive, or when the determination of Step S106 is positive, the extraction device 100 extracts a video which is captured at the timing at which the undesirable action is determined to have been performed or the timing at which a desirable action is determined to have been performed (Step S108). For example, the extraction device 100 extracts a video in a predetermined time before that timing. Then, the extraction device 100 transmits the extracted video to the provider server 200. The extraction device 100 may acquire information such as position information, weather information, and time information in which the video has been captured along with the video. The extraction device 100 acquires the position information from a position identifying part for identifying position information or another device. The extraction device 100 may acquire the weather information from another device or may estimate the weather on the basis of an image in which the host device has been imaged.

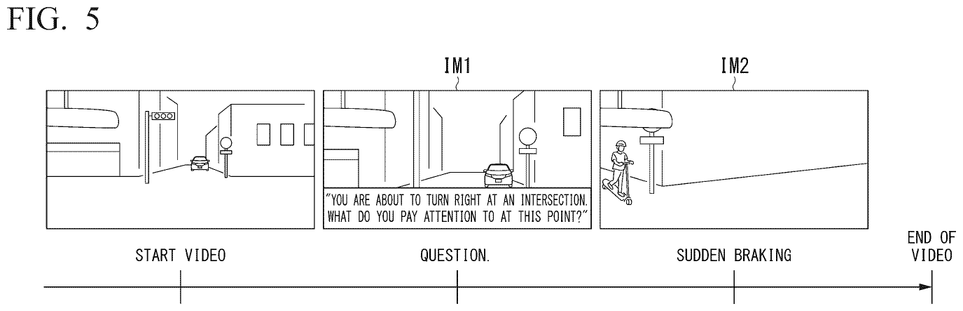

For example, when a series of desirable actions are performed, the extraction device 100 may extract a video at a predetermined time before the timing of the final desirable action (for example, the timing at which the vehicle stops at a crosswalk and allows a pedestrian to cross the crosswalk). For example, when a series of undesirable actions are performed, the extraction device 100 may extract a video in a predetermined time before the timing of the final undesirable action (for example, the timing of the final action of the series of undesirable actions in a predetermined time (an image IM2 in FIG. 5 which will be described later)). In this way, this routine of the flowchart ends.

In this way, the extraction device 100 can extract a video when a desirable action has been unintentionally performed or a video when an undesirable action has been unintentionally performed. Accordingly, the extraction device 100 can easily support provision of information of a scene which is shared by other persons.

### [Flowchart (2)]

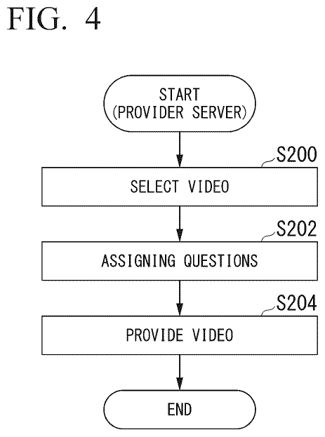

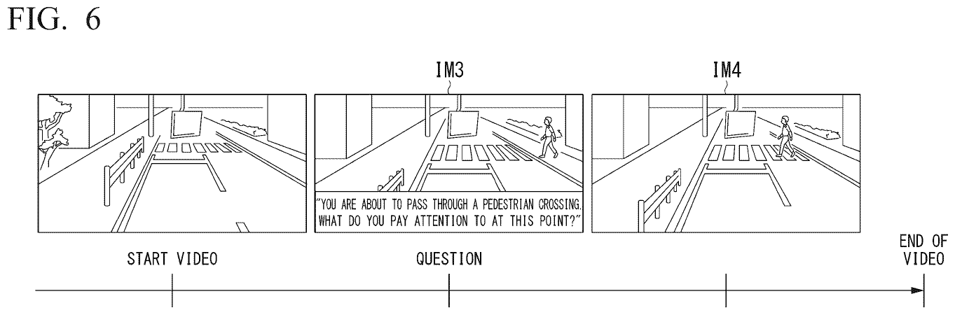

FIG. 4 is a flowchart illustrating an example of a process flow that is performed by the provider server 200. First, the provider server 200 selects a predetermined video out of the extraction data 260 (Step S200). Then, the provider server 200 assigns a question to the selected video (Step S202). Then, the provider server 200 generates video content on the basis of the video to which a question has been assigned and provides the generated video content to the user terminal device 400 (Step S204). The video content is content that presents a question corresponding to the type of the action before performing the action and does not require an answer to the question (see FIGS. 5 and 6 which will be described). In this way, this routine of the flowchart ends.

### [Specific Example (1) of Video Content Provided to User]

FIG. 5 is a diagram illustrating video content which is provided by the provider server 200. The video content illustrated in FIG. 5 is video content of an undesirable action. A question is displayed in a telop in the video (IM1) at a predetermined time after the video starts. At the timing at which the telop is displayed, the video may stop for a predetermined time. At this time, the user can think about the question. For example, a telop “You are about to turn right at an intersection. What do you pay attention to at this point?” is displayed. Thereafter, a video (IM2) in which an electric scooter travels straightly at the timing at which the vehicle turns right and the vehicle brakes quickly is displayed, and the video ends.

### [Specific Example (2) of Video Content Provided to User]

FIG. 6 is a diagram illustrating video content which is provided by the provider server 200. The video content illustrated in FIG. 6 is video content of a desirable action. A question is displayed in a telop in the video (IM3) in a predetermined time after the video starts. At the timing at which the telop is displayed, the video may stop for a predetermined time. At this time, the user can think about the question. For example, a telop “You are about to cross a pedestrian crossing. What do you pay attention to at this point?” is displayed. Thereafter, a video (IM4) in which the vehicle stops before the pedestrian crossing and a pedestrian crosses the pedestrian crossing is displayed, and the video ends.

In this way, the provider server 200 can provide video content which is useful for a driver to the user. For example, a driver can learn better driving or cautions in driving with reference to the video content.

Here, the information processing part 210 of the provider server 200 may generate video content by assigning different questions depending on the video types. For example, the information processing part 210 may input a video (one or more images) to a trained model which is not illustrated and assign a question on the basis of the video type output from the trained model. The trained model is a trained model which is trained to output a type according to an input video when a video (a plurality of images) is input thereto. The trained model is a model which has learned training data. The training data is, for example, information in which a video type and a video are correlated.

For example, correspondence information is prepared in advance. The correspondence information is information in which a video type and a question are correlated. The information processing part 210 assigns a question corresponding to the video type output from the trained model to the video with reference to the correspondence information. For example, a question “Do you see a nearby vehicle?” may be assigned to a video in which the vehicle changes the lane in front of another vehicle, or a question “Is something hidden in a dead angle of an oncoming vehicle?” may be assigned to a video in which a motorbike runs out from the dead angle of the oncoming vehicle.

The correspondence information may be information in which a video type, information of an environment (such as weather, date and time such as daytime or nighttime, season, and road conditions), and a question are correlated. The road conditions are, for example, information which is acquired by causing the provider server 200 to analyze an image. In this case, the information processing part 210 assigns different questions to a video depending on the environment even for the same video type (event). In this way, the provider server 200 can automatically assign a question corresponding to a video type (an event).

### [Another Example of Processes in Provider Server]

The provider server 200 may provide video content corresponding to a route along which a user is scheduled to travel to the user in addition to assigning a question as described above. This process will be described below.

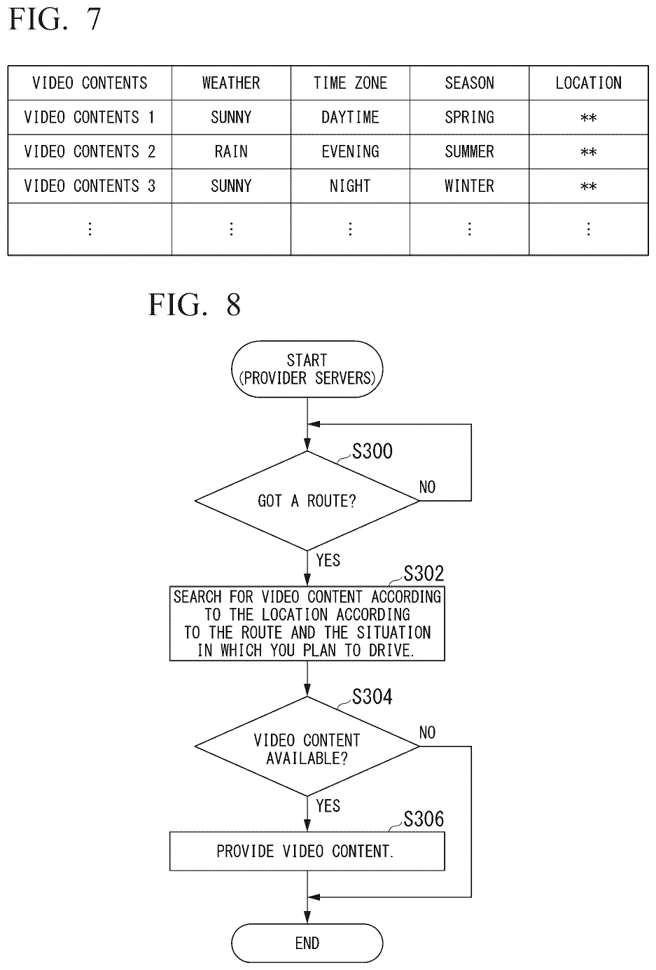

FIG. 7 is a diagram illustrating an example of details of the extraction data 260 stored in the storage part 250 of the provider server 200. The extraction data 260 is information in which a video content, the weather, a time period, a season, and a position are correlated. The weather, the time period, and the season correspond to a video content correlated therewith. The weather, the time period, and the season are information which has been transmitted along with the video content by the extraction device 100. The provider server 200 generates video content by assigning a question to the extraction data 260 as described above or as will be described below and provides the video content to a user.

### [Flowchart (3)]

FIG. 8 is a flowchart illustrating an example of a process flow that is performed by the provider server 200. First, the provider server 200 determines whether a route has been acquired from the user terminal device 400 (Step S300). When a route has been acquired from the user terminal device 400, the provider server 200 retrieves a position along the route and video content corresponding to a scheduled traveling situation from the extraction data 260 (Step S302). For example, the provider server 200 retrieves video content at a position along which the user is scheduled to travel, the video content corresponding to the weather, the time period, and the season which are predicted when the user travels.

Then, the provider server 200 determines whether the video content is present as a result of retrieval (Step S304). When the video content is not present, this routine of the flowchart ends. When the video content is present, the provider server 200 provides the video content to the user terminal device (Step S306). In this way, this routine of the flowchart ends.

### [Video Content Provided to User]

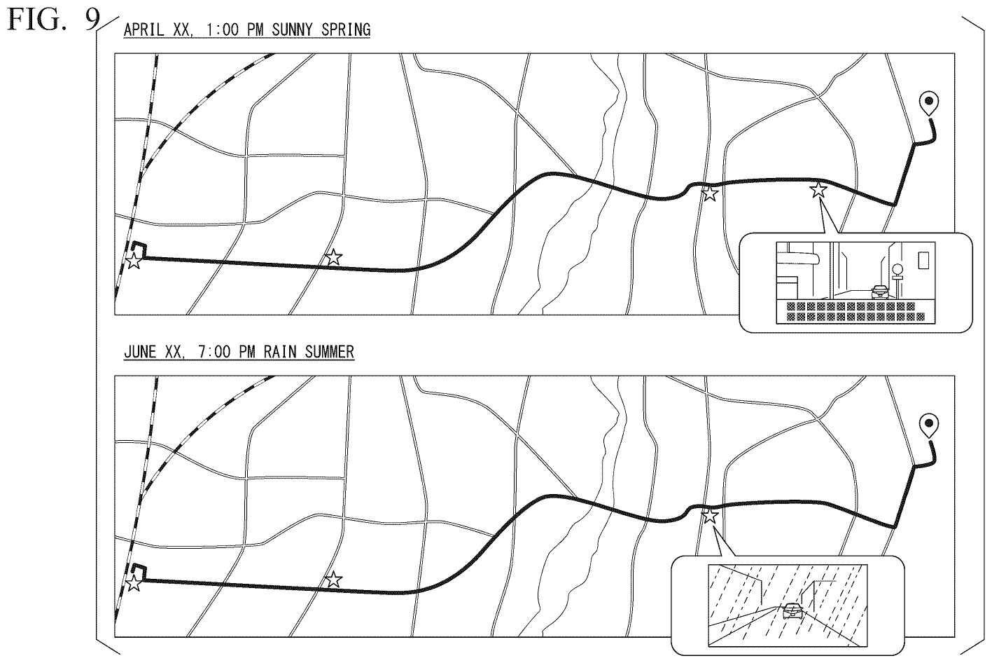

Through the aforementioned process, content corresponding to a user route and a situation is provided to the user as illustrated in FIG. 9. For example, when a user retrieves a predetermined route to travel to a destination at a predetermined date and time using a route retrieval service, the provider server 200 provides video content corresponding to the time period, the weather, and the season of the predetermined date and time and corresponding to the position along the route to the user terminal device 400. At this time, the provider server 200 provides information indicating that the video content is present in correlation with the position along the route to the user terminal device 400.

In the example illustrated in the upper part of FIG. 9, for example, since a user drives to a destination in the daytime, video content corresponding to the daytime is provided to the user. In the example illustrated in the lower part of FIG. 9, since a user drives to a destination in rains in the nighttime, video content corresponding to the nighttime and rain is provided to the user.

In this way, the provider server 200 can provide video content corresponding to a situation in which a user travels.

### [Learning Device]

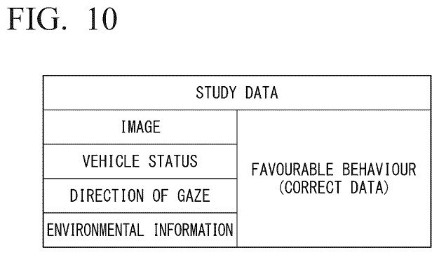

The learning device 300 generates a trained model 194 and provides the generated trained model 194 to the extraction device 100. The learning device 300 generates the trained model 194 by training a pre-learning model (an opportunistic learning model such as a neural network) using training data. FIG. 10 is a diagram illustrating an example of training data. The training data is information in which an image in which correct-answer data (a desirable action or an undesirable action) is correlated with combined information of the image a surrounding situation of the vehicle, a state (such as a degree of change of acceleration or a yaw rate) of the vehicle, information indicating a direction of a gaze, and environment information (such as weather, date and time, and season). The learning device 300 generates the trained model 194 by training a model to output information indicating correct-answer data correlated with the combined information when the combined information is input to the model.

The trained model 194 outputs information indicating that an undesirable action has been performed when the behavior of the vehicle deviates from a criterion based on a situation in an image by a predetermined value or more. The trained model 194 outputs information indicating that an undesirable action has been performed when the direction of a gaze deviates from a criterion direction based on the situation in the image by a predetermined value or more.

For example, when a driver's gaze is not directed to an electric scooter and deceleration has not been performed, a label of an undesirable action is correlated with the combined information of the image IM1, the state of the vehicle, information indicating a direction of a gaze, and environment information as illustrated in FIG. 5. The pre-training model is trained to output information indicating an undesirable action when the combined information is input thereto.

For example, when a driver's gaze is directed to the electric scooter and quick deceleration has been performed, a label of an undesirable action is correlated with the combined information of the image IM2, the state of the vehicle, information indicating a direction of a gaze, and environment information as illustrated in FIG. 5. The pre-training model is trained to output information indicating an undesirable action when the combined information is input thereto.

For example, when a driver's gaze is directed to a pedestrian and deceleration has been performed, a label of a desirable action is correlated with the combined information of the image IM3, the state of the vehicle, information indicating a direction of a gaze, and environment information as illustrated in FIG. 6. The pre-training model is trained to output information indicating a desirable action when the combined information is input thereto.

For example, when a driver's gaze is directed to a pedestrian and the vehicle stops at a zero speed, a label of a desirable action is correlated with the combined information of the image IM4, the state of the vehicle, information indicating a direction of a gaze, and environment information as illustrated in FIG. 6. The pre-training model is trained to output information indicating a desirable action when the combined information is input thereto.

In the aforementioned examples, the combined information is a combination of an image, a vehicle state, information indicating a direction of a gaze, and environment information, but some of this information may be omitted. For example, the image or the direction of a gaze may be omitted. In this case, information in which combined information not including the omitted information is correlated with correct-answer data is used as training data to generate a trained model 194. Then, the extraction device 100 performs processes using the trained model 194. Information which is input to the trained model 194 at that time is the combined information not including the omitted information.

As described above, the learning device 300 generates the trained model 194 using training data. In this way, the learning device 300 can more accurately generate a trained model that outputs whether a driver has performed a desirable action or an undesirable action.

For example, a near-miss video does not provide sufficient information from a viewpoint in which information is scattered in the world, in what place (spot) an event has occurred is not known in detail, and the video is used to prevent an accident in actually passing through that place. When a video is old, road conditions may have changed and thus the video may not be used (a universal part of the aforementioned near-miss video can be used for training but is not appropriate for usage such as “Be cautious about driving because this event has occurred in this place in this time period!).

By automatically extracting a near-miss part from a video, generating a quiz “Then what happened?,” and storing the quiz in the provider server 200, it is possible to continue to provide video content which is real and hot. This video can be accessed from a route retrieval screen. The provider server 200 deletes and updates old videos from time to time, but may leave a video which has been often seen.

The information provision device 1 can support a person with a desire “I want to learn!” (such as a beginner or a person having caused a critical accident in the past) (voluntary social contribution). The information provision device 1 may display a near-miss video which was captured on the traveling route in the past in cooperation with a navigation device (since a user does not know what spot of a strange road is dangerous, the user can prepare in advance and have a breathing space in mind). For example, the information provision device 1 displays a near-miss video which occurred on a route in the past at the time of retrieval of the route. For example a user can see a near-miss video which actually occurred in a target place through a predetermined operation at the time of retrieval of a route and study specific dangers in advance before traveling.

According to the aforementioned embodiment, the information provision device 1 can easily provide information of a scene which is shared by other persons by providing video content corresponding to a type of an action.

The aforementioned embodiment can be expressed as follows:

A device including:

a storage medium storing computer-readable instructions; and

a processor connected to the storage medium,

wherein the processor executes the computer-readable instructions to perform:
detecting behavior of a vehicle;
determining whether driving of the vehicle performed by a driver is a desirable action or an undesirable action with respect to a predetermined criterion on the basis of one or both of the detected behavior of the vehicle and an image captured by an imaging part that images a surrounding situation of the vehicle;
extracting a first image in a first predetermined time before a first time at which the desirable action has been performed or a second image in a second predetermined time before a second time at which the undesirable action has been performed out of images captured by the imaging part; and
providing content corresponding to a type of the action using the extracted image.

While an embodiment of the present invention has been described above, the present invention is not limited to the embodiment and can be subjected to various modifications and substitutions without departing from the gist of the present invention.

### REFERENCE SIGNS LIST

1 Information provision device

100 Extraction device

110 Imaging part

120 State detecting part

130 Gaze detecting part

140 Determination part

150 Extraction part

160 Transmission control part

192 Image data (video data)

194 Trained model

200 Provider server

210 Information processing part

260 Extraction data

300 Learning device

What is claimed is:

1. An information provision device comprising:
a detection part configured to detect behavior of a vehicle;
a determination part configured to determine whether driving of the vehicle performed by a driver is a desirable action or an undesirable action with respect to a predetermined criterion on the basis of one or both of the behavior of the vehicle detected by the detection part and an image captured by an imaging part that images a surrounding situation of the vehicle;
an extraction part configured to extract a first image in a first predetermined time before a first time at which the desirable action has been performed or a second image in a second predetermined time before a second time at which the undesirable action has been performed out of images captured by the imaging part; and
a provision part configured to provide content corresponding to a type of the action using the extracted image.

2. The information provision device according to claim 1, wherein the content includes the first image or the second image, presents a question corresponding to the type of the action before performing the action, and does not require an answer to the question.

3. The information provision device according to claim 1, wherein the determination part determines whether driving of the vehicle performed by the driver is a desirable action or an undesirable action with respect to the predetermined criterion on the basis of the image captured by the imaging part and the behavior of the vehicle, and
wherein the determination part determines whether driving of the vehicle performed by the driver is a desirable action or an undesirable action with respect to the predetermined criterion by inputting the image and the behavior of the vehicle to a trained model which has been trained to output a type of the action when the image and the behavior of the vehicle are input thereto.

4. The information provision device according to claim 2, wherein the determination part determines whether driving of the vehicle performed by the driver is a desirable action or an undesirable action with respect to the predetermined criterion on the basis of the image captured by the imaging part and the behavior of the vehicle, and
wherein the determination part determines whether driving of the vehicle performed by the driver is a desirable action or an undesirable action with respect to the predetermined criterion by inputting the image and the behavior of the vehicle to a trained model which has been trained to output a type of the action when the image and the behavior of the vehicle are input thereto.

5. The information provision device according to claim 1, further comprising a gaze detecting part configured to detect a direction of a gaze of the driver,
wherein the determination part determines whether driving of the vehicle performed by the driver is a desirable action or an undesirable action with respect to the predetermined criterion on the basis of information indicating the image captured by the imaging part, the behavior of the vehicle, and the direction of the gaze, and
wherein the determination part determines whether driving of the vehicle performed by the driver is a desirable action or an undesirable action with respect to the predetermined criterion by inputting the image, the behavior of the vehicle, and the information indicating the direction of the gaze to a trained model which has been trained to output a type of the action when the image, the behavior of the vehicle, and the information indicating the direction of the gaze are input thereto.

6. The information provision device according to claim 2, further comprising a gaze detecting part configured to detect a direction of a gaze of the driver,
wherein the determination part determines whether driving of the vehicle performed by the driver is a desirable action or an undesirable action with respect to the predetermined criterion on the basis of information indicating the image captured by the imaging part, the behavior of the vehicle, and the direction of the gaze, and
wherein the determination part determines whether driving of the vehicle performed by the driver is a desirable action or an undesirable action with respect to the predetermined criterion by inputting the image, the behavior of the vehicle, and the information indicating the direction of the gaze to a trained model which has been trained to output a type of the action when the image, the behavior of the vehicle, and the information indicating the direction of the gaze are input thereto.

7. The information provision device according to claim 5, wherein the trained model is a model which has been trained using training data,
wherein the training data includes the image, the behavior of the vehicle, the information indicating the direction of the gaze, and correct-answer data, and
wherein the correct-answer data is information indicating a type of an action based on a combination of the image, the behavior of the vehicle, and the information indicating the direction of the gaze.

8. The information provision device according to claim 6, wherein the trained model is a model which has been trained using training data,
wherein the training data includes the image, the behavior of the vehicle, the information indicating the direction of the gaze, and correct-answer data, and
wherein the correct-answer data is information indicating a type of an action based on a combination of the image, the behavior of the vehicle, and the information indicating the direction of the gaze.

9. The information provision device according to claim 7, wherein the trained model outputs information indicating that the undesirable action has been performed when the behavior of the vehicle deviates from the criterion based on the situation in the image by a predetermined value or more, or
wherein the trained model outputs information indicating that the undesirable action has been performed when the direction of the gaze deviates from a criterion direction based on the situation in the image by a predetermined value or more.

10. The information provision device according to claim 8, wherein the trained model outputs information indicating that the undesirable action has been performed when the behavior of the vehicle deviates from the criterion based on the situation in the image by a predetermined value or more, or
wherein the trained model outputs information indicating that the undesirable action has been performed when the direction of the gaze deviates from a criterion direction based on the situation in the image by a predetermined value or more.

11. The information provision device according to claim 1, wherein the detection part is mounted in the vehicle or a device installed in the vehicle, and
wherein the determination part is provided in a device other than the vehicle.

12. The information provision device according to claim 2, wherein the detection part is mounted in the vehicle or a device installed in the vehicle, and
wherein the determination part is provided in a device other than the vehicle.

13. An information provision method that is performed by a computer, the information provision method comprising:
detecting behavior of a vehicle;
determining whether driving of the vehicle performed by a driver is a desirable action or an undesirable action with respect to a predetermined criterion on the basis of one or both of the detected behavior of the vehicle and an image captured by an imaging part that images a surrounding situation of the vehicle;
extracting a first image in a first predetermined time before a first time at which the desirable action has been performed or a second image in a second predetermined time before a second time at which the undesirable action has been performed out of images captured by the imaging part; and
providing content corresponding to a type of the action using the extracted image.

14. A program causing a computer to perform:
detecting behavior of a vehicle;
determining whether driving of the vehicle performed by a driver is a desirable action or an undesirable action with respect to a predetermined criterion on the basis of one or both of the detected behavior of the vehicle and an image captured by an imaging part that images a surrounding situation of the vehicle;
extracting a first image in a first predetermined time before a first time at which the desirable action has been performed or a second image in a second predetermined time before a second time at which the undesirable action has been performed out of images captured by the imaging part; and
providing content corresponding to a type of the action using the extracted image.
